(19) United States
(12) Patent Application Publication
(10) Pub. No.: US 2026/0148733 A1
(43) Pub. Date: May 28, 2026

(54) VOICE-PRESERVING MULTI-LINGUAL SPEECH AUDIO TRANSLATION

(71) Applicants: Adobe Inc., San Jose, CA (US); The Trustees of Princeton University, Princeton, NJ (US)

(72) Inventors: Jiaqi SU, San Francisco, CA (US); Zeyu JIN, San Francisco, CA (US); Yunyun WANG, Princeton, NJ (US); Adam FINKELSTEIN, Princeton, NJ (US)

(21) Appl. No.: 18/958,501

(22) Filed: Nov. 25, 2024

(51) Int. Cl. G10L 13/033; G10L 15/00

(52) U.S. Cl. CPC G10L 13/0335; G10L 15/005

(57) ABSTRACT

Embodiments are disclosed for preserving a vocal identity of an input audio sequence when translating speech audio. The method may include receiving an input audio sequence that includes speech audio having a source vocal identity in a first language. The method may further comprise translating a first transcription of the speech audio to a second transcription in a second language. Using the second transcription, initial translated speech audio having a default vocal identity is generated. The method may further comprise processing the initial translated speech audio to generate a translated content embedding and translated intonation data and processing the input audio sequence to generate a source speaker embedding representing the source vocal identity of the speech audio. The method may further comprise generating final translated speech audio with the source vocal identity in the second language, using the source speaker embedding, the translated content embedding, and the translated intonation data.

### BACKGROUND

Media creation is important for both novice and skilled creators for the creation of media content (e.g., films, television shows, etc.) and social media content. To reach the widest global audience possible, media creators have the desire for their media content to be accessible in multiple different languages. However, translating media content in a way that produces desirable results can pose significant challenges.

### SUMMARY

Introduced here are techniques/technologies that allow a voice-preserving audio translation system to translate source speech audio in a first language into a second language, while preserving the vocal identity of the speaker of the source speech audio.

More specifically, in one or more embodiments, a voice-preserving audio translation system is trained to translate speech audio while preserving the voice of the original speaker in the speech audio. Upon receiving an audio sequence and a target language type indicating a language to translate the speech audio into, the voice-preserving audio translation system processes the speech audio through a pipeline of modules and neural networks. The speech audio is transcribed, translated, and then passed through a text-to-speech model to generate translated speech audio in the target language. The audio sequence can be further processed to extract out background sounds (e.g., noise, music, sound events, etc.) and impulse response data. The original speech audio is processed through an encoder that generates a speaker embedding. The speaker embedding can be a vector representation of characteristics of the voice of the original speaker. The translated speech audio in the target language is processed through an encoder to generate a content embedding representing the speech content of the speech audio and a pitch detector to generate intonation data for the translated speech audio. The speaker embedding The voice-preserving audio translation system can process the speaker embedding, the content embedding, and the intonation data, resulting in an output audio sequence that has been translated into the target language, while having the same voice or characteristics of the voice of the original speaker. The output audio sequence can be further remixed with the previously extracted background sounds and impulse response data.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating vocal identity-preserving speech audio in a target language from source speech audio in a source language in accordance with one or more embodiments;

FIG. 2 illustrates a diagram of a process of generating speech audio features given an input speech audio in accordance with one or more embodiments;

FIG. 3 illustrates a diagram of a process of generating speech audio in a target language based on source language speech audio features and target language speech audio features in accordance with one or more embodiments;

FIG. 4 illustrates a diagram of a process of training machine learning models to generate vocal identity-preserving speech audio in a target language from source speech audio in a source language in in accordance with one or more embodiments;

FIG. 5 illustrates a schematic diagram of a voice-preserving audio translation system in accordance with one or more embodiments;

FIG. 6 illustrates a flowchart of a series of acts in a method of translating source speech audio from a source language to a target language, while preserving the vocal identity of the speaker of the source speech audio in accordance with one or more embodiments; and

FIG. 7 illustrates a block diagram of an exemplary computing device in accordance with one or more embodiments.

### DETAILED DESCRIPTION

One or more embodiments of the present disclosure include a voice-preserving audio translation system translating speech content in a source audio sequence from a source language to a target language, while preserving the vocal identity of the speaker of the speech content in the source audio sequence. Existing techniques for audio translation are inadequate for as they are not able to handle the complexity inherent to real world media (e.g., background noise, music, etc.). For example, typical dubbing techniques involves replacing the original spoken content of a piece of media (e.g., audio, video, etc.) with translated spoken content in a different language. This may be done manually be hiring actors and technicians to translate the spoken content and having actors recite the translated spoken content. However, this can be resource and time-intensive for hobbyists and smaller content creators. In addition, hiring actors to recite translated dialogue does not preserve the vocal identity of the original speaker. Other existing techniques the can also perform language translations are unable to synchronize the translated speech content with the underlying video sequence. In addition, other existing techniques require a clean source audio sequence that does not include any background noises or sound events, thereby limiting their suitability for produced video content.

To address these and other deficiencies in conventional systems, the voice-preserving audio translation system of the present disclosure can process an audio sequence that includes source speech audio in an original language and automatically translate the source speech audio into a requested language, while preserving the vocal identity of the original speaker in the source speech audio. The source speech audio in the original language is first processed through a speech recognition engine to obtain a transcript and timestamps for segments of the source speech audio. The transcript is passed through a translation engine to obtain a translated transcript in the requested language. The translated transcript is passed through a text-to-speech engine to generate speech audio in the requested language. The speech audio in the requested language may be in a different voice (e.g., a default voice of the text-to-speech engine). The content embedding and intonation data from the speech audio in the second language are then processed with a speaker embedding generated from the source speech audio to generate the translated speech audio with the vocal identity of the original speaker in the source speech audio.

The voice-preserving audio translation system of the present disclosure presents improved audio translation, while addressing the limitations of the existing techniques. One advantage of the voice-preserving audio translation system of the present disclosure is the ability to preserve the original voice in the original speech audio. Further, the ability to manipulate the speaking rate of each segment (e.g., sentence) of the translated speech audio allows for it to be overlain in synchronization with a corresponding video sequence without the need to re-render the video sequence with the translated speech audio. In addition to conserving resources, the ability to synch the translated speech audio with the video sequence can produce more impactful and accessible outputs. For example, when playing a video on a video streaming platform, a user can select a translation (e.g., from a menu) and the translated speech audio can be automatically played in sync with the video. Another advantage of the voice-preserving audio translation system is the preservation of the extraction of the background music, sounds, and noise events from the original audio sequence for remixing with the translated speech audio.

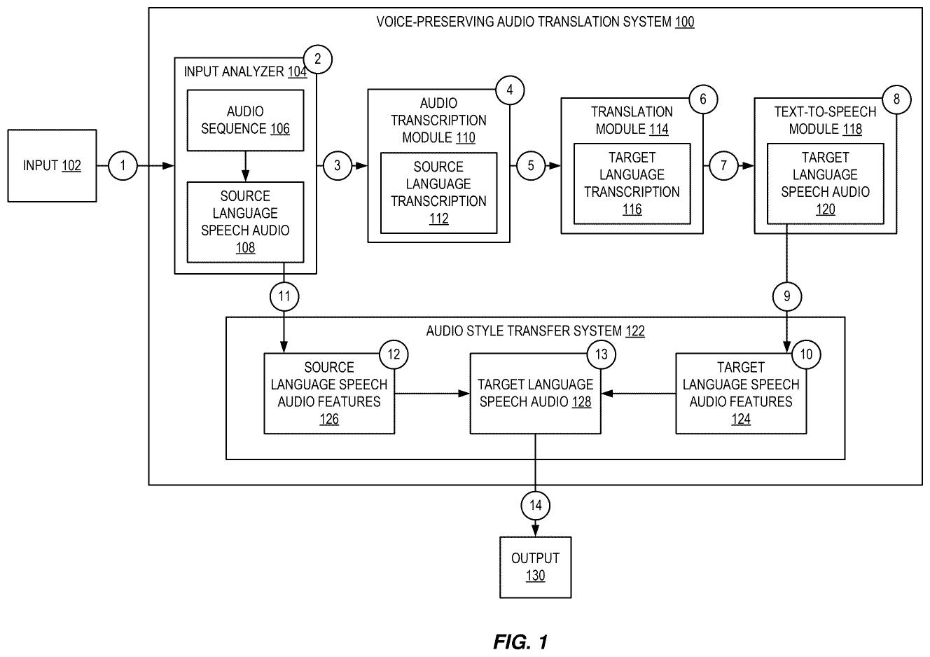

FIG. 1 illustrates a diagram of a process of generating voice-preserving speech audio in a target language from source speech audio in a source language in accordance with one or more embodiments. As shown in FIG. 1, a voice-preserving audio translation system 100 receives an input 102, as shown at numeral 1. For example, the voice-preserving audio translation system 100 receives the input 102 from a user via a computing device or from a memory or storage location, where the input 102 includes at least an audio sequence (e.g., audio sequence 106). The audio sequence 106 can be an audio waveform that is a mixture of various types of audio events (e.g., speech, non-speech audio, etc.). In one or more embodiments, the input 102 can include a video sequence that includes speech audio. In one or more embodiments, the speech audio is associated with a source vocal identity (e.g., the speaker of the speech audio). In one or more embodiments, the input 102 further includes a target language identifier indicating a language type being requested for translation of speech audio in the audio sequence 106. In some embodiments, the audio sequence 106 and the target language identifier can be received in a single input 102 or in multiple inputs. For example, the target language identifier can be provided through a selection of one or more language types (e.g., from a menu or selectable list). In one or more embodiments, the input 102 can be provided in a graphical user interface (GUI). For example, the audio sequence 106 can be provided to the voice-preserving audio translation system 100, or a user can indicate a storage location (e.g., on a computing device) or a URL to a location storing the audio sequence 106.

In one or more embodiments, the voice-preserving audio translation system 100 includes an input analyzer 104 that receives the input 102. In some embodiments, the input analyzer 104 is configured to extract source language speech audio 108 from the input 102, at numeral 2. In one or more embodiments, the source language speech audio 108 can be extracted by a different module than the input analyzer 104. In some embodiments, the speech audio from the source language speech audio 108 is obtained by extracting background noise and impulse response data from the source language speech audio 108. In one or more embodiments, the source language speech audio 108 is speech audio of a speaker in a source language. In some embodiments, the audio sequence 106 can include multiple speakers, which can each be extracted into separate source language speech audios 108. In one or more embodiments, the audio sequence 106 can be further processed to extract background noise and impulse response data.

The input analyzer 104 then sends the source language speech audio 108 to an audio transcription module 110, as shown at numeral 3. In one or more embodiments, the audio transcription module 110 generates a source language transcription 112, at numeral 4. The source language transcription 112 is a text-based representation of the source language speech audio 108. In one or more embodiments, the audio transcription module 110 segments the source language speech audio 108 into a plurality of segments and associates a timestamp with each of the plurality of segments. In some embodiments, each segment of the plurality of segments includes a single sentence and a single speaker.

The source language transcription 112 is then sent to a translation module 114, as shown at numeral 5. In one or more embodiments, the target language identifier is also sent to the translation module 114. In one or more embodiments, the translation module 114 generates a target language transcription 116, at numeral 6. The translation module 114 can be configured to generate a target language transcription 116 by translating the source language transcription 112 from the source language to the target language indicated by the target language identifier. In one or more embodiments, the translation module 114 translates each of the plurality of segments of the source language transcription 112 into the target language. The timestamps corresponding to each segment of the plurality of segments can also be stored with the target language transcription 116. The target language transcription 116 is then sent to a text-to-speech module 118, as shown at numeral 7.

In one or more embodiments, the text-to-speech module 118 processes the target language transcription 116 to generate target language speech audio 120, at numeral 8. In one or more embodiments, the text-to-speech module 118 can be a text-to-speech system configured to synthesize speech audio based on the target language transcription 116. In one or more embodiments, the text-to-speech module 118 synthesizes each segment of the target language transcription 116 separately. In such embodiments, the text-to-speech module 118 can further process each segment of the target language speech audio 120 based on their corresponding timestamps. For example, if the length of a segment of the target language speech audio 120 is shorter than the length of the corresponding segment of the source language speech audio 108, the speaking rate can be decreased. Conversely, if the length of a segment of the target language speech audio 120 is longer than the length of the corresponding segment of the source language speech audio 108, the speaking rate can be increased. This allows for the target language speech audio 120 to be in sync when the source language speech audio 108 is from a speaker of a video sequence. In one or more embodiments, the vocal identity of the target language speech audio 120 can be a default vocal identity of the text-to-speech module 118. The target language speech audio 120 is then sent to an audio style transfer system 122, as shown at numeral 9.

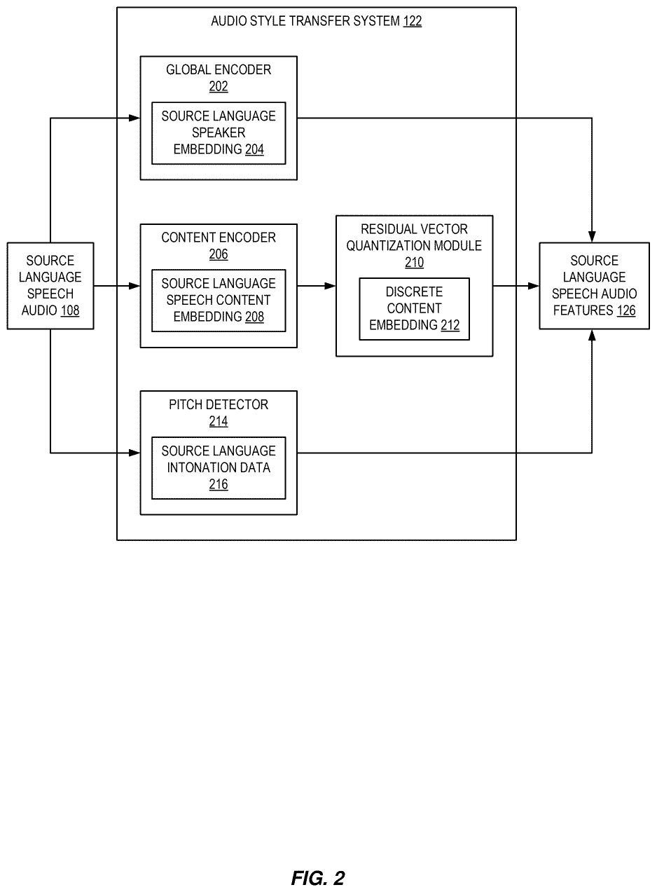

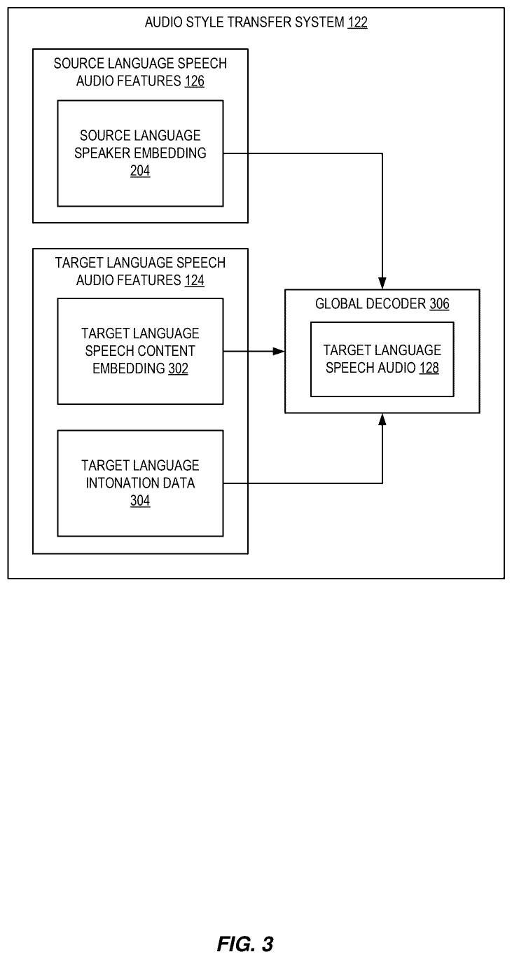

In one or more embodiments, the audio style transfer system 122 is configured to generate audio features for input speech audio and to generate output speech audio using neural networks. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. FIGS. 2 and 3 illustrate diagrams of neural networks used by the voice-preserving audio translation system in accordance with one or more embodiments.

In one or more embodiments, the audio style transfer system 122 generates target language speech audio features 124 from the target language speech audio 120, at numeral 10. In one or more embodiments, the target language speech audio features 124 can include a speaker embedding representing the default vocal identity of the text-to-speech module 118, a content embedding representing the speech content of the target language speech audio 120, and intonation data for the target language speech audio 120.

Serially, or concurrently, to the generation of the target language speech audio 120, the source language speech audio 108 can be sent to the audio style transfer system 122, as shown at numeral 11. In one or more embodiments, the audio style transfer system 122 generates source language speech audio features 126 from the source language speech audio 108, at numeral 12. In one or more embodiments, the source language speech audio features 126 can include a speaker embedding representing the source vocal identity of the speaker of the source language speech audio 108, a content embedding representing the speech content of the source language speech audio 108, and intonation data for the source language speech audio 108.

In one or more embodiments, the audio style transfer system 122 then processes features from the target language speech audio features 124 and the source language speech audio features 126 to generate target language speech audio 128, at numeral 13. In one or more embodiments, the audio style transfer system 122 processes the speaker embedding representing the source vocal identity of the speaker of the source language speech audio 108, the content embedding representing the speech content of the target language speech audio 120, and intonation data for the target language speech audio 120 to generate the target language speech audio 128. The resulting target language speech audio 128 has the speech content and intonation data of the target language, while preserving the vocal identity of the speaker of the source language speech audio 108. In one or more embodiments, the background noise and impulse response data previously extracted from the audio sequence 106 can be convolved, or mixed, into the target language speech audio 128. In some embodiments, acoustic matching is performed on the target language speech audio 128 to match the acoustic quality to the original input audio sequence or video sequence, which may be of higher or lower quality than the target language speech audio 128.

The target language speech audio 128 can be sent as an output 130, as shown at numeral 14. In one or more embodiments, after the process described above in numerals 1-12, the output 130 is sent through a communications channel to the user device or computing device that provided the input, to another computing device associated with the user or another user, or to another system or application.

FIG. 2 illustrates a diagram of a process of generating speech audio features given an input speech audio in accordance with one or more embodiments. While the process in FIG. 2 is described with respect to generating source language speech audio features 126 from the source language speech audio 108, the process is identical for generating target language speech audio features 124 from the target language speech audio 120.

As illustrated in FIG. 2, the audio style transfer system 122 includes a global encoder 202, a content encoder 206, a residual vector quantization module 210, and a pitch detector. In one or more embodiments, the global encoder 202 is trained to generate a source language speaker embedding 204 that represents the vocal identity of the speaker of the source language speech audio 108. In one or more embodiments, the global encoder 202 summarizes a mel-spectrogram into a one-dimensional vector that represents the voice characteristics of the speaker of the source language speech audio 108. In one or more embodiments, the content encoder 206 is a feature extractor trained to extract source language speech content embedding 208, which represents the speech content of the source language speech audio 108. In some embodiments, the content embedding can be further refined by passing the source language speech content embedding 208 through residual vector quantization module 210, resulting in discrete content embedding 212. In one or more embodiments, the pitch detector is configured to analyze the source language speech audio 108 and generate source language intonation data 216 (e.g., pitch data). In some embodiments, the pitch detector 214 is the Pitch Estimating Neural Networks (PENN) system. The source language speaker embedding 204, source language speech content embedding 208 (or discrete content embedding 212), and the source language intonation data 216 can be provided as the source language speech audio features 126.

FIG. 3 illustrates a diagram of a process of generating speech audio in a target language based on source language speech audio features and target language speech audio features in accordance with one or more embodiments. Continuing the example from FIGS. 1 and 2, the source language speaker embedding 204 is passed to a global decoder 306. In addition, a target language speech content embedding 302 and target language intonation data 304 (e.g., generated in a process similar to that described in FIG. 2) are passed to the global decoder 306. In one or more embodiments, the global decoder 306 is trained to decode the source language speaker embedding 204, the target language speech content embedding 302, and the target language intonation data 304 into a clean mel-spectrogram (e.g., the target language speech audio 128). In one or more embodiments, background noise and impulse response information can be convolved with the target language speech audio 128 to generate the final output.

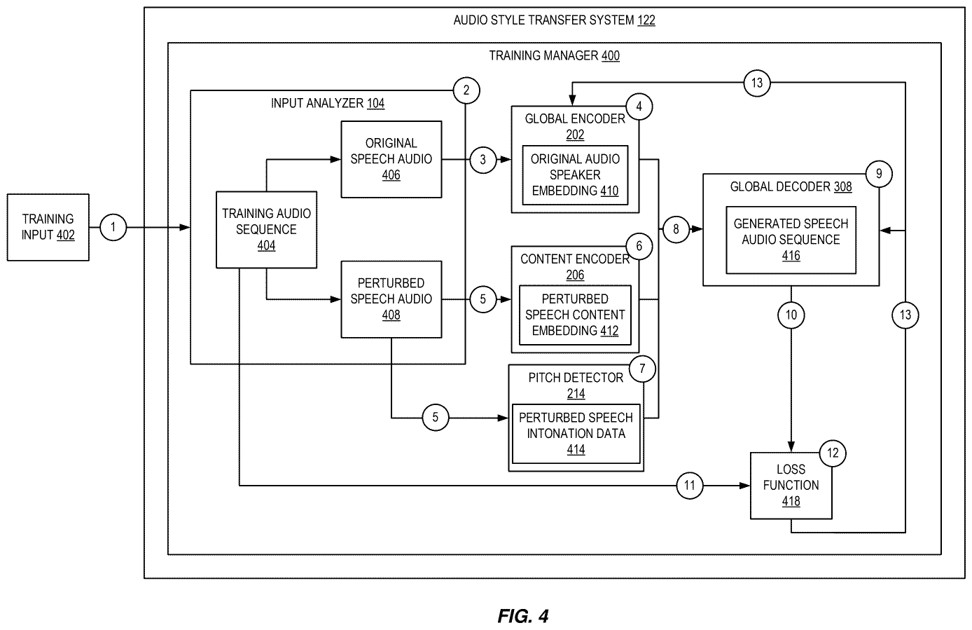

FIG. 4 illustrates a diagram of a process of training machine learning models to generate vocal identity-preserving speech audio in a target language from source speech audio in a source language in in accordance with one or more embodiments. In one or more embodiments, a training manager 400 is configured to train neural networks (e.g., global encoder 202 and global decoder 308) to generate translated speech audio that preserve the vocal identity of the speaker of the original speech audio.

In some embodiments, the training manager 400 is a part of a voice-preserving audio translation system 100. In other embodiments, the training manager 400 can be a standalone system, or part of another system, and deployed to the voice-preserving audio translation system 100. For example, the training manager 400 may be implemented as a separate system implemented on electronic devices separate from the electronic devices implementing voice-preserving audio translation system 100. As shown in FIG. 4, the training manager 400 receives a training input 402, as shown at numeral 1. For example, the voice-preserving audio translation system 100 receives the training input 402 from a user via a computing device or from a memory or storage location. In one or more embodiments, the training input 402 can be provided in a graphical user interface (GUI). For example, the training audio sequence 404 can be provided to the voice-preserving audio translation system 100, or a user can indicate a storage location (e.g., on a computing device) or a URL to a location storing the training audio sequence 404. The training input 402 can be part of a batch that includes multiple training audio sequences 404 that can be fed to the training manager 400 in parallel or in series.

In one or more embodiments, the voice-preserving audio translation system 100 includes an input analyzer 104 that receives the training input 402. In some embodiments, the input analyzer 104 is configured to extract the training audio sequence 404 from the training input 402 and generate original speech audio 406 and perturbed speech audio 408, at numeral 2. In one or more embodiments, the input analyzer 104 extracts the original speech audio 406 from the training audio sequence 404. In one or more embodiments, the source language speech audio 108 can be extracted by a different module than the input analyzer 104. In one or more embodiments, perturbed speech audio 408 is then generated from the training audio sequence 404. In one or more embodiments, the perturbed speech audio 408 is generated by applying a perturbation to the training audio sequence 404, such as a pitch shift and/or a prosody shift, that causes a change to the vocal identity of the speaker in the original speech audio 406.

The input analyzer 104 then sends the original speech audio 406 to a global encoder 202, as shown at numeral 3. In one or more embodiments, the global encoder 202 generates an original audio speaker embedding representing the vocal identity of the speaker in the original speech audio 406, at numeral 4. In one or more embodiment, serially or concurrently, the perturbed speech audio 408 is sent to a content encoder 206 and a pitch detector 214, as shown at numeral 5. In one or more embodiments, the content encoder 206 generates a perturbed speech content embedding 412, representing the speech content of the perturbed speech audio 408, as shown at numeral 6. In one or more embodiments, the pitch detector 214 generates perturbed speech intonation data 414, representing the pitch of the perturbed speech audio 408, as shown at numeral 7. The original audio speaker embedding 410, the perturbed speech content embedding 412, and the perturbed speech intonation data 414 are passed to the global decoder 308, as shown at numeral 8.

In one or more embodiments, the global decoder 308 generates a generated speech audio sequence 416, at numeral 9. In one or more embodiments, the global decoder 308 is trained to decode the original audio speaker embedding 410, the perturbed speech content embedding 412, and the perturbed speech intonation data 414 into a clean mel-spectrogram. The generated speech audio sequence 416 represents a reconstruction of the training audio sequence 404 by applying the vocal identity of the original speaker in the training audio sequence 404 to the perturbed speech content embedding 412 and the perturbed speech intonation data 414.

After the global decoder 308 generates the generated speech audio sequence 416, is sent to loss function 418, as shown at numeral 10. The training audio sequence 404 from the training input 402 is then passed to the loss function 418 as the ground truth, as shown at numeral 11. Using the generated speech audio sequence 416 and the training audio sequence 404, the loss function 418 can calculate a loss, at numeral 12. In one or more embodiments, the loss function 418 is an L2 reconstruction loss.

The calculated loss can then be backpropagated to train the global encoder 202 and the global decoder 308, as shown at numeral 13.

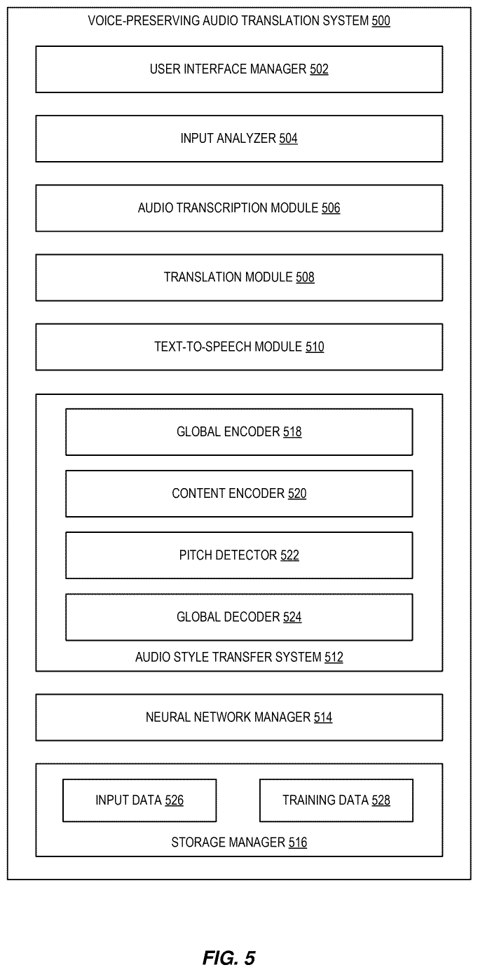

FIG. 5 illustrates a schematic diagram of a voice-preserving audio translation system (e.g., “voice-preserving audio translation system” described above) in accordance with one or more embodiments. As shown, the voice-preserving audio translation system 500 may include, but is not limited to, a user interface manager 502, an input analyzer 504, an audio transcription module 506, a translation module 508, a text-to-speech module 510, an audio style transfer system 512, a neural network manager 514, and a storage manager 516. In one or more embodiments, the audio style transfer system 512 includes a global encoder 518, a content encoder 520, a pitch detector 522, and a global decoder 524. The storage manager 516 includes input data 526 and training data 528.

As illustrated in FIG. 5, the voice-preserving audio translation system 500 includes a user interface manager 502. For example, the user interface manager 502 allows users to provide input data to the voice-preserving audio translation system 500. In some embodiments, the user interface manager 502 provides a user interface through which the user can upload a document or file (e.g., an audio sequence), as discussed above. Alternatively, or additionally, the user interface may enable the user to download the document or file from a local or remote storage location (e.g., by providing an address, such as a URL or other endpoint, associated with a data source).

As further illustrated in FIG. 5, the voice-preserving audio translation system 500 also includes an input analyzer 504 that receives an input (e.g., from the user interface manager 502). The input analyzer 504 analyzes the input received to identify at least an audio sequence from the input. In embodiments where the voice-preserving audio translation system 500 performs audio extraction, the input analyzer 504 analyzes the input to identify speech audio from the audio sequence.

As further illustrated in FIG. 5, the voice-preserving audio translation system 500 also includes an audio transcription module 506 configured to generate a text transcript of the speech audio of an audio sequence. As further illustrated in FIG. 5, the voice-preserving audio translation system 500 also includes a translation module 508 configured to translate the text transcript of the speech audio of the audio sequence from a first language to a second language. As further illustrated in FIG. 5, the voice-preserving audio translation system 500 also includes a text-to-speech module 510 configured to generate an audio sequence from the translated text transcript in the second language.

As further illustrated in FIG. 5, the voice-preserving audio translation system 500 also includes an audio style transfer system 512. The audio style transfer system 512 includes components for generating an output speech audio sequence in a target language when given an input speech audio sequence in a source language. In one or more embodiments, the components of the audio style transfer system 512 include neural networks. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In one or more embodiments, the audio style transfer system 512 includes a global encoder 518, a content encoder 520, a pitch detector 522, and a global decoder 524. In one or more embodiments, the global encoder 518 is a neural network model trained to generate a speech embedding representing the vocal identity of the speaker of a speech audio sequence. In one or more embodiments, the content encoder 520 is a neural network model trained to generate a content embedding representing the speech content of a speech audio sequence. In one or more embodiments, the pitch detector 522 is configured to extract intonation data from the speech audio sequence. In one or more embodiments, the global decoder 524 is a neural network model trained to generate an output speech audio sequence from the speech embedding of a source speech audio sequence and the content embedding and intonation data of a target speech audio sequence.

As illustrated in FIG. 5, the voice-preserving audio translation system 500 also includes a neural network manager 514. Neural network manager 514 may host a plurality of neural networks or other machine learning models used by the modules of the voice-preserving audio translation system 500. The neural network manager 514 may include an execution environment, libraries, and/or any other data needed to execute the machine learning models. In some embodiments, the neural network manager 514 may be associated with dedicated software and/or hardware resources to execute the machine learning models. Although depicted in FIG. 5 as being hosted by a single neural network manager 514, in various embodiments the neural networks may be hosted in multiple neural network managers and/or as part of different components.

As illustrated in FIG. 5, the voice-preserving audio translation system 500 also includes the storage manager 516. The storage manager 516 maintains data for the voice-preserving audio translation system 500. The storage manager 516 can maintain data of any type, size, or kind as necessary to perform the functions of the voice-preserving audio translation system 500. The storage manager 516, as shown in FIG. 5, includes input data 526 and training data 528. In particular, the input data 526 may include an audio sequence received by the voice-preserving audio translation system 500 for which a translated audio sequence is requested. In some embodiments, the input data 526 may include a target language identifier indicating a language type for translation. The training data 528 may include a training audio sequence used to train the encoders and decoders of the audio style transfer system 512.

Each of the components 502-516 of the voice-preserving audio translation system 500 and their corresponding elements (as shown in FIG. 5) may be in communication with one another using any suitable communication technologies. It will be recognized that although components 502-516 and their corresponding elements are shown to be separate in FIG. 5, any of components 502-516 and their corresponding elements may be combined into fewer components, such as into a single facility or module, divided into more components, or configured into different components as may serve a particular embodiment.

The components 502-516 and their corresponding elements can comprise software, hardware, or both. For example, the components 502-516 and their corresponding elements can comprise one or more instructions stored on a computer-readable storage medium and executable by processors of one or more computing devices. When executed by the one or more processors, the computer-executable instructions of the voice-preserving audio translation system 500 can cause a client device and/or a server device to perform the methods described herein. Alternatively, the components 502-516 and their corresponding elements can comprise hardware, such as a special purpose processing device to perform a certain function or group of functions. Additionally, the components 502-516 and their corresponding elements can comprise a combination of computer-executable instructions and hardware.

Furthermore, the components 502-516 of the voice-preserving audio translation system 500 may, for example, be implemented as one or more stand-alone applications, as one or more modules of an application, as one or more plug-ins, as one or more library functions or functions that may be called by other applications, and/or as a cloud-computing model. Thus, the components 502-516 of the voice-preserving audio translation system 500 may be implemented as a stand-alone application, such as a desktop or mobile application. Furthermore, the components 502-516 of the voice-preserving audio translation system 500 may be implemented as one or more web-based applications hosted on a remote server. Alternatively, or additionally, the components of the voice-preserving audio translation system 500 may be implemented in a suite of mobile device applications or “apps.”

As shown, the voice-preserving audio translation system 500 can be implemented as a single system. In other embodiments, the voice-preserving audio translation system 500 can be implemented in whole, or in part, across multiple systems. For example, one or more functions of the voice-preserving audio translation system 500 can be performed by one or more servers, and one or more functions of the voice-preserving audio translation system 500 can be performed by one or more client devices. The one or more servers and/or one or more client devices may generate, store, receive, and transmit any type of data used by the voice-preserving audio translation system 500, as described herein.

In one implementation, the one or more client devices can include or implement at least a portion of the voice-preserving audio translation system 500. In other implementations, the one or more servers can include or implement at least a portion of the voice-preserving audio translation system 500. For instance, the voice-preserving audio translation system 500 can include an application running on the one or more servers or a portion of the voice-preserving audio translation system 500 can be downloaded from the one or more servers. Additionally, or alternatively, the voice-preserving audio translation system 500 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including audio sequences stored at the one or more servers. The one or more servers can then automatically perform the methods and processes described above to translate source speech audio from a source language to a target language, while preserving the vocal identity of the speaker of the source speech audio.

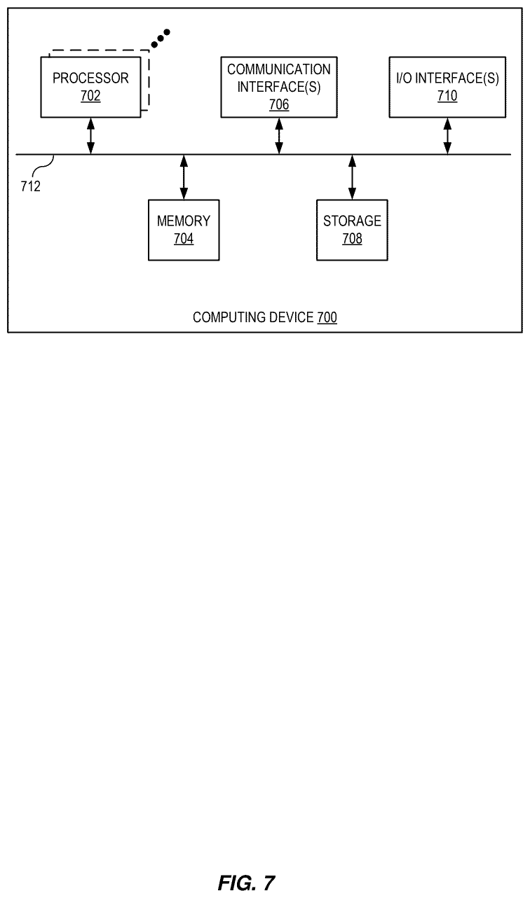

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

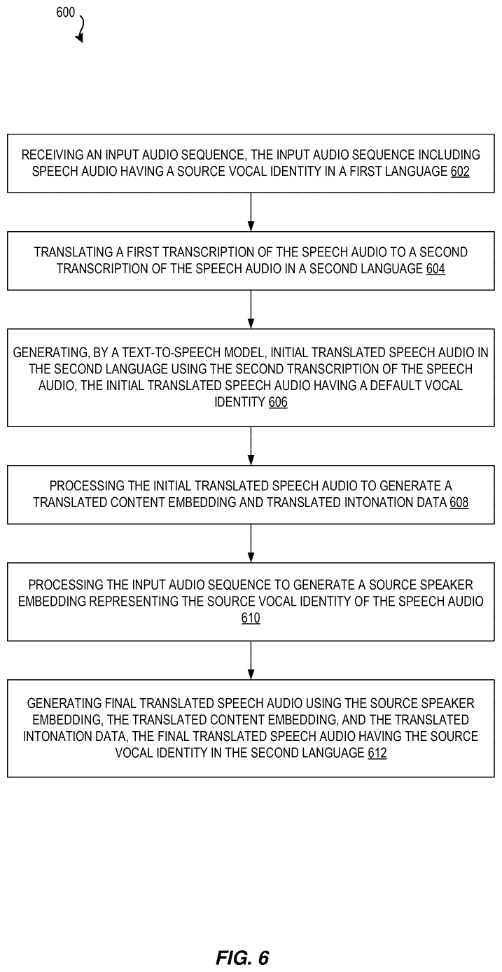

FIGS. 1-5, the corresponding text, and the examples, provide a number of different systems and devices that translate source speech audio from a source language to a target language, while preserving the vocal identity of the speaker of the source speech audio in accordance with one or more embodiments. In addition to the foregoing, embodiments can also be described in terms of flowcharts comprising acts and steps in a method for accomplishing a particular result. For example, FIG. 6 illustrates a flowchart of an exemplary method in accordance with one or more embodiments. The method described in relation to FIG. 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of a series of acts in a method of translating source speech audio from a source language to a target language, while preserving the vocal identity of the speaker of the source speech audio in accordance with one or more embodiments. In one or more embodiments, the method 600 is performed in a digital medium environment that includes the voice-preserving audio translation system 500. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of receiving an input audio sequence, the input audio sequence including speech audio having a source vocal identity in a first language. In one or more embodiments, a voice-preserving audio translation system (e.g., voice-preserving audio translation system 500) receives an input that includes an audio sequence. The voice-preserving audio translation system can also receive the target language identifier that indicates a language to translate the audio sequence into. In one or more embodiments, the audio sequence and the target language identifier are received in a single input. In other embodiments, the audio sequence and the target language identifier are received in multiple inputs. For example, the target language identifier can be received in a graphical user interface (GUI) after the audio sequence has been received by the voice-preserving audio translation system.

As illustrated in FIG. 6, the method 600 includes an act 604 of translating a first transcription of the speech audio to a second transcription of the speech audio in a second language. In one or more embodiments, the voice-preserving audio translation system generates a first transcription of the speech audio. In one or more embodiments, an audio transcription module segments the speech audio into a plurality of source segments and generates a text transcription of each source segment. The plurality of source segments can be stored with timestamp information indicating a start time and an end time for the corresponding source segment of the speech audio. A translation module can then generate the second transcription by translating each of the plurality of source segments into a plurality of target segments in a second language (e.g., the language indicated by the target language identifier). The timestamp information corresponding to each of the plurality of source segments can also be stored with the second transcription.

As illustrated in FIG. 6, the method 600 includes an act 606 of generating, by a text-to-speech model, initial translated speech audio in the second language using the second transcription of the speech audio, the initial translated speech audio having a default vocal identity In one or more embodiments, the text-to-speech model is a text-to-speech system configured to synthesize speech audio based on the second transcription. In one or more embodiments, the text-to-speech model generates translated audio segments for each of the plurality of translated segments in the second transcription. In one or more embodiments, the text-to-speech model further processes and can modify each translated audio segment based on the corresponding timestamps from the speech audio of the input audio sequence. For example, if the length of a translated audio segment of the translated speech audio is shorter than the length of the corresponding segment of the speech audio of the input audio sequence, the speaking rate can be decreased. Conversely, if the length of a segment of the translated speech audio is longer than the length of the corresponding segment of the speech audio of the input audio sequence, the speaking rate can be increased. This allows for the translated audio segment to be in sync with a speaker of the speech audio of the input audio sequence. In one or more embodiments, the vocal identity of the target language speech audio can be a default vocal identity of the text-to-speech model that is different from the speaker of the speech audio of the input audio sequence.

As illustrated in FIG. 6, the method 600 includes an act 608 of processing the initial translated speech audio to generate a translated content embedding and translated intonation data. In one or more embodiments, a content encoder extracts the translated content embedding, which represents the speech content of the translated speech audio. In some embodiments, the content embedding can be further refined by passing the translated content embedding through a residual vector quantization module, resulting in a discrete content embedding. In one or more embodiments, a pitch detector is configured to analyze the translated speech audio and generate translated intonation data (e.g., pitch data). In some embodiments, the pitch detector is the Pitch Estimating Neural Networks (PENN) system. In one or more embodiments, a translated speaker embedding can also be generated by a global encoder, representing the default vocal identity of the translated speech audio.

As illustrated in FIG. 6, the method 600 includes an act 610 of processing the input audio sequence to generate a source speaker embedding representing the source vocal identity of the speech audio. In one or more embodiments, a global encoder is trained to generate a source speaker embedding that represents the vocal identity of the speaker of the speech audio. In one or more embodiments, the global encoder summarizes a mel-spectrogram into a one-dimensional vector that represents the voice characteristics of the speaker of the speech audio. In one or more embodiments, a content embedding and intonation data for the speech audio can also be generated by the content encoder and pitch detector, respectively.

As illustrated in FIG. 6, the method 600 includes an act 612 of generating final translated speech audio using the source speaker embedding, the translated content embedding, and the translated intonation data, the final translated speech audio having the source vocal identity in the second language. In one or more embodiments, the global decoder is trained to decode the source speaker embedding, the translated content embedding, and the translated intonation data into a clean mel-spectrogram (e.g., the final translated speech audio). In one or more embodiments, background noise and impulse response information can be convolved with the final translated speech audio to generate the final output.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the voice-preserving audio translation system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example, and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving an input audio sequence, the input audio sequence including speech audio having a source vocal identity in a first language;
translating a first transcription of the speech audio to a second transcription of the speech audio in a second language;
generating, by a text-to-speech model, initial translated speech audio in the second language using the second transcription of the speech audio, the initial translated speech audio having a default vocal identity;
processing the initial translated speech audio to generate a translated content embedding and translated intonation data;
processing the input audio sequence to generate a source speaker embedding representing the source vocal identity of the speech audio; and
generating final translated speech audio using the source speaker embedding, the translated content embedding, and the translated intonation data, the final translated speech audio having the source vocal identity in the second language.

2. The method of claim 1, wherein translating the first transcription of the speech audio to the second transcription of the speech audio in the second language further comprises:
generating a first transcription of the speech audio by:
segmenting the speech audio into a plurality of source segments;
generating a translation for each source segment of the plurality of source segments; and
storing timestamps for each source segment of the plurality of source segments with a corresponding generated translation.

3. The method of claim 2, wherein generating the initial translated speech audio in the second language using the second transcription of the speech audio further comprises:
generating translated segments for each of the plurality of translated segments; and
modifying a speaking rate for each of the translated segments based on the timestamps for a corresponding source segment.

4. The method of claim 1, wherein processing the initial translated speech audio to generate a translated content embedding and translated intonation data further comprises:
generating, by an encoder model, the translated content embedding representing speech content of the initial translated speech audio; and
generating, by a pitch detector, the translated intonation data.

5. The method of claim 1, wherein processing the input audio sequence to generate a source speaker embedding representing the source vocal identity of the speech audio further comprises:
generating, by an encoder model, the source speaker embedding representing the source vocal identity of the speech audio by processing a mel-spectrogram of the speech audio.

6. The method of claim 1, further comprising:
obtaining the speech audio from the input audio sequence by extracting background noise and impulse response data from the input audio sequence.

7. The method of claim 6, wherein generating the final translated speech audio using the source speaker embedding, the translated content embedding, and the translated intonation data further comprises:
generating an output audio sequence by convolving the background noise and impulse response data from the input audio sequence with the final translated speech audio.

8. A non-transitory computer-readable medium storing executable instructions, which when executed by a processing device, cause the processing device to perform operations comprising:
receiving an input audio sequence, the input audio sequence including speech audio having a source vocal identity in a first language;
translating a first transcription of the speech audio to a second transcription of the speech audio in a second language;
generating, by a text-to-speech model, initial translated speech audio in the second language using the second transcription of the speech audio, the initial translated speech audio having a default vocal identity;
processing the initial translated speech audio to generate a translated content embedding and translated intonation data;
processing the input audio sequence to generate a source speaker embedding representing the source vocal identity of the speech audio; and
generating final translated speech audio using the source speaker embedding, the translated content embedding, and the translated intonation data, the final translated speech audio having the source vocal identity in the second language.

9. The non-transitory computer-readable medium of claim 8, wherein the instructions to translate the first transcription of the speech audio to the second transcription of the speech audio in the second language further comprise:
generating a first transcription of the speech audio by:
segmenting the speech audio into a plurality of source segments;
generating a translation for each source segment of the plurality of source segments; and
storing timestamps for each source segment of the plurality of source segments with a corresponding generated translation.

10. The non-transitory computer-readable medium of claim 9, wherein the instructions to generate the initial translated speech audio in the second language using the second transcription of the speech audio further comprise:
generating translated segments for each of the plurality of translated segments; and
modifying a speaking rate for each of the translated segments based on the timestamps for a corresponding source segment.

11. The non-transitory computer-readable medium of claim 8, wherein the instructions to process the initial translated speech audio to generate a translated content embedding and translated intonation data further comprise:
generating, by an encoder model, the translated content embedding representing speech content of the initial translated speech audio; and
generating, by a pitch detector, the translated intonation data.

12. The non-transitory computer-readable medium of claim 8, wherein the instructions to process the input audio sequence to generate a source speaker embedding representing the source vocal identity of the speech audio further comprise:
generating, by an encoder model, the source speaker embedding representing the source vocal identity of the speech audio by processing a mel-spectrogram of the speech audio.

13. The non-transitory computer-readable medium of claim 8, further comprising:
obtaining the speech audio from the input audio sequence by extracting background noise and impulse response data from the input audio sequence.

14. The non-transitory computer-readable medium of claim 13, wherein the instructions to generate the final translated speech audio using the source speaker embedding, the translated content embedding, and the translated intonation data further comprise:
generating an output audio sequence by convolving the background noise and impulse response data from the input audio sequence with the final translated speech audio.

15. A system comprising:
a memory component; and
a processing device coupled to the memory component, the processing device to perform operations comprising:
receiving an input audio sequence, the input audio sequence including speech audio having a source vocal identity in a first language;
translating a first transcription of the speech audio to a second transcription of the speech audio in a second language;
generating, by a text-to-speech model, initial translated speech audio in the second language using the second transcription of the speech audio, the initial translated speech audio having a default vocal identity;
processing the initial translated speech audio to generate a translated content embedding and translated intonation data;
processing the input audio sequence to generate a source speaker embedding representing the source vocal identity of the speech audio; and
generating final translated speech audio using the source speaker embedding, the translated content embedding, and the translated intonation data, the final translated speech audio having the source vocal identity in the second language.

16. The system of claim 15, wherein the operations of translating the first transcription of the speech audio to the second transcription of the speech audio in the second language further comprise:
generating a first transcription of the speech audio by:
segmenting the speech audio into a plurality of source segments;
generating a translation for each source segment of the plurality of source segments; and
storing timestamps for each source segment of the plurality of source segments with a corresponding generated translation.

17. The system of claim 16, wherein the operations of generating the initial translated speech audio in the second language using the second transcription of the speech audio further comprise:
generating translated segments for each of the plurality of translated segments; and
modifying a speaking rate for each of the translated segments based on the timestamps for a corresponding source segment.

18. The system of claim 15, wherein the operations of processing the initial translated speech audio to generate a translated content embedding and translated intonation data further comprise:
generating, by an encoder model, the translated content embedding representing speech content of the initial translated speech audio; and
generating, by a pitch detector, the translated intonation data.

19. The system of claim 17, wherein the operations of processing process the input audio sequence to generate a source speaker embedding representing the source vocal identity of the speech audio further comprise:
generating, by an encoder model, the source speaker embedding representing the source vocal identity of the speech audio by processing a mel-spectrogram of the speech audio.

20. The system of claim 15, wherein the operations of generating the final translated speech audio using the source speaker embedding, the translated content embedding, and the translated intonation further comprise:
extracting background noise and impulse response data from the input audio sequence; and
generating an output audio sequence by convolving the background noise and impulse response data from the input audio sequence with the final translated speech audio.
